(19) United States
(12) Patent Application Publication
(10) Pub. No.: US 2004/0140685 A1
(43) Pub. Date: Jul. 22, 2004

(54) Storage compartment

(76) Inventors: Torsten Bieck, Waldachtal (DE); Gunter Leopold, Baiersbronn (DE); Tsehaye Gebrehiwet, Stuttgart (DE); Hans-Georg Peters, Ammerbuch (DE); Inge Schierling, Nuernberg (DE); Uwe Frederking, Leinfelden (DE)

Correspondence Address: STRIKER, STRIKER & STENBY, 103 East Neck Road, Huntington, NY, 11743, US

(21) Appl. No.: 10/735,984

(22) Filed: Dec. 15, 2003

(30) Foreign Application Priority Data
Dec. 19, 2002 (DE) 102 59 414.7

(51) Int. Cl. B60N 3/12

(52) U.S. Cl. 296/37.12

(57) ABSTRACT

A storage compartment assembly has a first storage compartment having a housing and an opening, an internal compartment arranged in the first storage compartment and having an access face, the internal compartment being mounted on the housing of the first storage compartment so as to be pivotable between a closed position in which the access face is unaccessible and an open position accessible via the opening of the first storage compartment, a lever mechanism, and a guide track means having a control curve, the lever mechanism and the guide track being formed so to couple the cover, the internal compartment and the housing so that when the first compartment is closed, the internal compartment is likewise pivoted from the open position into the closed position.

### BACKGROUND OF THE INVENTION

The present invention generally relates to storage compartments.

Storage compartments having a pivotally opening cover are widely known, for example, as glove compartments in motor vehicles. A problem with such compartments is that, on account of the spatial conditions, it is frequently the case that although a considerable amount of space is available within the compartment it can be only poorly utilized because the pivoting of the cover allows only limited access to the interior of the compartment. The space underneath the console in the front passenger space or within the glove compartment could be utilized, for example, for the integration of a CD changer for an audio system.

### SUMMARY OF THE INVENTION

It is therefore an object of the present invention to provide a storage compartment which is a further improvement of the existing storage compartments.

In particular, it is an object of the present invention to arrange within a storage compartment a further compartment which can be opened separately.

In keeping with these objects one feature of the present invention resides in a storage compartment assembly, comprising a first storage compartment having a housing and an opening; an internal compartment arranged in said first storage compartment and having an access face, said internal compartment being mounted on said housing of said first storage compartment so as to be pivotable between a closed position in which said access face is unaccessible and an open position accessible via said opening of said first storage compartment; a lever mechanism; and a guide track means having a control curve, said lever mechanism and said guide track being formed so to couple said cover, said internal compartment and said housing so that when said first compartment is closed, said internal compartment is likewise pivoted from said open position into said closed position.

The internal compartment should in the first instance be closed when the storage compartment is opened. Only after manual operation should an access face of the internal compartment become accessible through the opening in the storage compartment. The internal compartment should close automatically when the storage compartment is closed. Such automatic closing should be effected in a way such that damage cannot be caused to the cover of the storage compartment or to the internal compartment.

According to the invention, inside a storage compartment having a pivotable cover there is arranged an internal compartment having an access face. The internal compartment is itself likewise pivotally mounted in the housing of the storage compartment and can be opened and closed manually. The cover, the internal compartment and the housing are so coupled by way of a lever mechanism and a guidetrack means that when the storage compartment is closed the opened internal compartment likewise closes.

The internal compartment can be used, for housing a CD changer within a glove compartment. The operating elements of the CD changer are arranged on the access face of the internal compartment. The internal compartment can be held in the closed position, for example, by a catch. By manual operation, the catch can be released and the internal compartment pivoted by means of gravity and/or the action of a spring. The pivoting movement can also be damped.

In the downwardly pivoted position the operating elements of the CD changer are accessible in the region of the opening of the glove compartment. The CD changer can then be pivoted back by manual lifting of the internal compartment and in so doing locked back in the catch. By the use of a lever mechanism in association with a guidetrack means it can be ensured that the automatic closing of the internal compartment does not result in the internal compartment's colliding with the cover or with the contents of the storage compartment. For example, the control curve of the guidetrack means can be so configured that even only slight pivoting of the cover results in a storage pivoting movement of the internal compartment, while in the almost closed position pivoting the cover through a large angle produces only a small angle of pivot or no pivoting of the internal compartment. This is important particularly when, for example in the case of a CD changer, easily damaged components are arranged on the access face of the internal compartment.

In a preferred embodiment, the storage compartment has a lever mechanism having a lever which is pivotally mounted in the housing of the storage compartment. At the rear end of the lever there is arranged a pin which engages in the control curve of the guidetrack means arranged on the internal compartment. At the forward end of the lever there is arranged a control surface to which a force is transmittable when the cover is closed. The transmission of the force can be effected either directly by a control lug arranged on the cover or by way of a control slider guided in the housing. When the lever is pivoted, the pin is guided in the control curve and thus forces the internal compartment to perform a pivoting movement.

Alternatively, the lever can be pivotally mounted in the internal compartment. At its rear end there is again arranged a pin but in this case the pin engages in the control curve arranged in the housing. At the forward end there is again arranged a control surface to which a force is transmittable when the cover is closed. Likewise, a control lug on the cover or a control slider guided in the housing can be used for the force transmission. Such an arrangement has the effect of moving the lever as a whole relative to the housing, because it is mounted in the internal compartment. When the lever is pivoted, the pin is again guided in the control curve, so that the pivot bearing of the lever is lowered or raised.

Various devices can be used to hold the internal compartment in the closed position. For example, in a preferred variant the internal compartment is held by a catch. This catch can be released manually, so that the internal compartment pivots into the opened position. In order to hold the internal compartment again when it is pivoted back, the pivoting movement of the internal compartment can, for example, perform a slight overtravel movement and thus lock into the catch.

For implementing the overtravel movement, the control lever can have at its rear end a displaceably mounted control head having the pin. The control head is acted upon by a spring which presses the control head against the closing pivoting movement of the lever. The control curve has a bend for the angle of pivot at which the overtravel movement is desired. The overtravel movement results in engagement in the catch. When the control curve is followed while the internal compartment is being pivoted into the opened position, the pin is initially arrested at the bend in the control curve on account of the displaceability of the control head. As a result, it is not forced to perform the overtravel movement and the internal compartment can be lowered directly.

As an alternative, the internal compartment can be held in the closed position solely by means of the control curve. For that purpose, the control curve of the guidetrack means is arcuately formed so that when the internal compartment is pivoted into the closed position an overtravel movement is performed and, after completion, a locking action is provided. In that case, the internal compartment is pivoted into the opened position by operation of the control lever. The operation of the control lever can be effected directly or indirectly by way of a button or the like.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows the storage compartment with the cover open and the internal compartment closed;

FIG. 2 shows the same storage compartment with the cover open and the internal compartment open;

FIG. 3 shows a further storage compartment with the cover open and the internal compartment closed, and

FIG. 4 shows the same storage compartment with the cover open and the internal compartment open.

### DESCRIPTION OF THE PREFERRED EMBODIMENTS

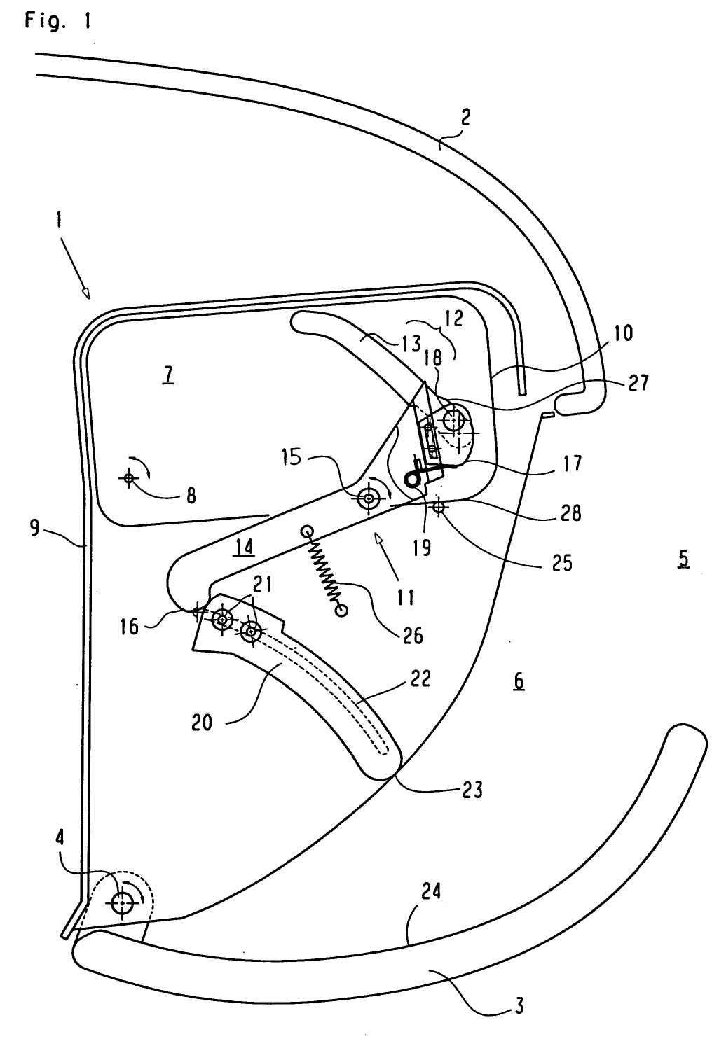

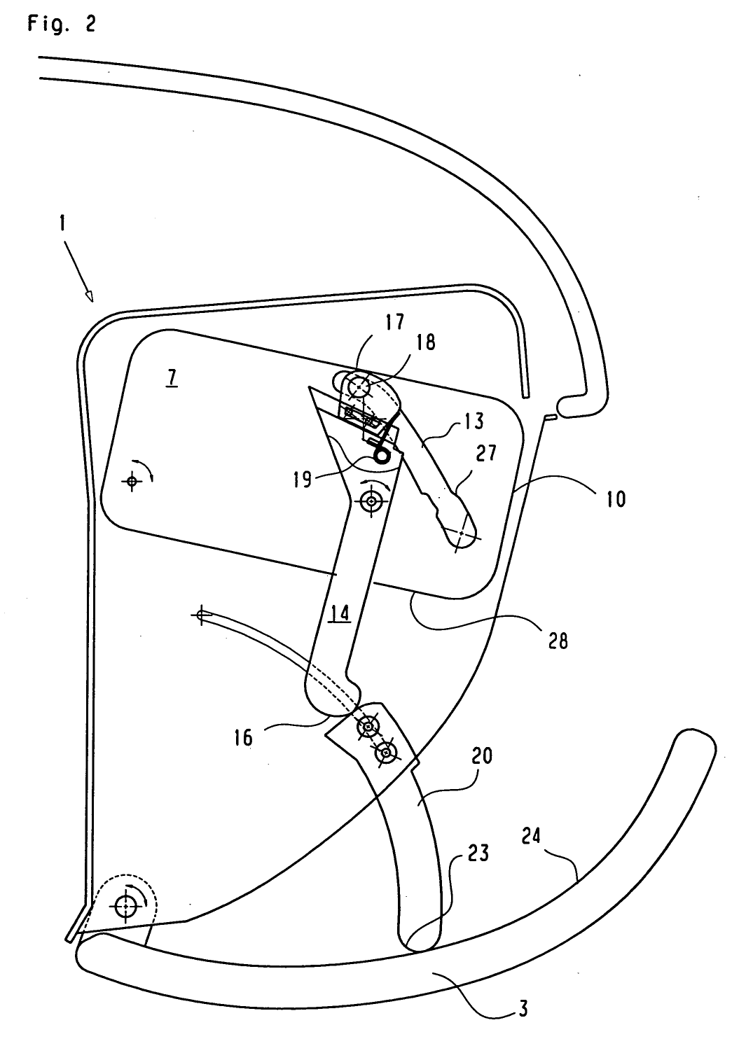

The storage compartment 1 shown in FIG. 1 is installed as glove compartment in the passenger space 2 of a motor vehicle. The cover 3 of the storage compartment 1 is pivotable about its pivot point 4 and can be locked in its closed position. The opening 5 gives access to the interior chamber 6 of the storage compartment 1. It can be used for the storage of maps, documents, gloves or the like. The internal compartment 7 is arranged in the upper region of the storage compartment 1. It is likewise mounted in the housing 9 using a pivot bearing 8 and can be pivoted into the interior chamber 6 of the storage compartment 1 so that its access face 10 is accessible through the opening 5 of the storage compartment 1 (see FIG. 2). The internal compartment 7 can be, for example, in the form of a housing for a CD changer or other electronic instrument or in the form of a further storage compartment.

The cover 3, internal compartment 7 and housing 9 are coupled by means of a lever mechanism 11 and a guidetrack means 12 having a control curve 13. The lever mechanism 11 consists of a lever 14, which is pivotally mounted by the lever joint 15 on the housing 9. At its forward end the lever 14 has a control surface 16. At its rear end there is arranged a displaceably mounted control head 17 having a pin 18 which engages in the control curve 13. The control head 17 is pressed upwards by means of the torsion spring 19. A control slider 20 rests against the control surface 16 of the lever 14. The control slider 20 is guided by the two guide pins 21 displaceably along a guide path 22 and is held in the position shown by frictional forces. Alternatively, it is possible to use a catch device, for example in the form of a ball catch, for holding the control slider 20. When the cover 3 is closed, the stop face 23 of the control slider 20 is in contact with the inner side 24 of the cover 3.

The operation of opening the internal compartment 7 can be initiated by displacement of the pin-shaped catch 25 perpendicular to the plane of the drawing. By virtue of gravity and/or the force of a spring, the internal compartment 7 is acted upon by a moment which results in its being lowered. In the embodiment shown, the spring 26 supports the lowering. At the same time, the operation can be braked by damping means (not shown). As a result of the pivoting movement of the internal compartment 7 the pin 18 is guided along the control curve 13 the pin 18 is delayed and the control head is displaced against the force of the torsion spring 19. As a result, further pivoting of the lever 14 does not result in the internal compartment 7 being lifted or in its pivoting movement being blocked. The pivoting movement of the lever 14 at the same time causes the control slider 20 to be displaced along the guide path 22 by way of the control surface 16.

As a result of the further lowering of the internal compartment 7, finally the position shown in FIG. 2 is achieved. When the internal compartment 7 is in this position, its access face 10 is accessible to the user. In the case of a CD changer, this can be used, for example, for changing the CDs or for altering the instrument settings. When the user has finished, the internal compartment can be closed by being lifted at the underside 28 of the internal compartment 7. As a result, the pin 18 travels along the control curve in the reverse direction. At the bend 27, the displaceability of the control head 17 enables the internal compartment 7 to be lifted over the catch 25 (see FIG. 1) so that the latter is able, for example, to engage resiliently below the underside 28.

When the cover 3 is closed while the internal compartment 7 is open, the contact between the stop face 23 of the control slider 20 and the inner side 24 of the cover 3 has the effect of displacing the control slider 20. The contact between the control surface 16 of the lever 14 and the control slider 20 causes the lever to pivot. The guidance of the pin 18 in the control curve 13 has the effect of lifting the internal compartment 7. The shape of the control surface 13 can be used to determine whether the internal compartment 7 is lifted uniformly or, for example, first by a large amount and then slowly. The bend 27 in the control curve 13 and the torsion spring 19 on the displaceable control head 17 give rise to an overtravel movement beyond the position shown in FIG. 1. It is thus again possible to implement engagement of the catch 25 (see FIG. 1) below the underside 28.

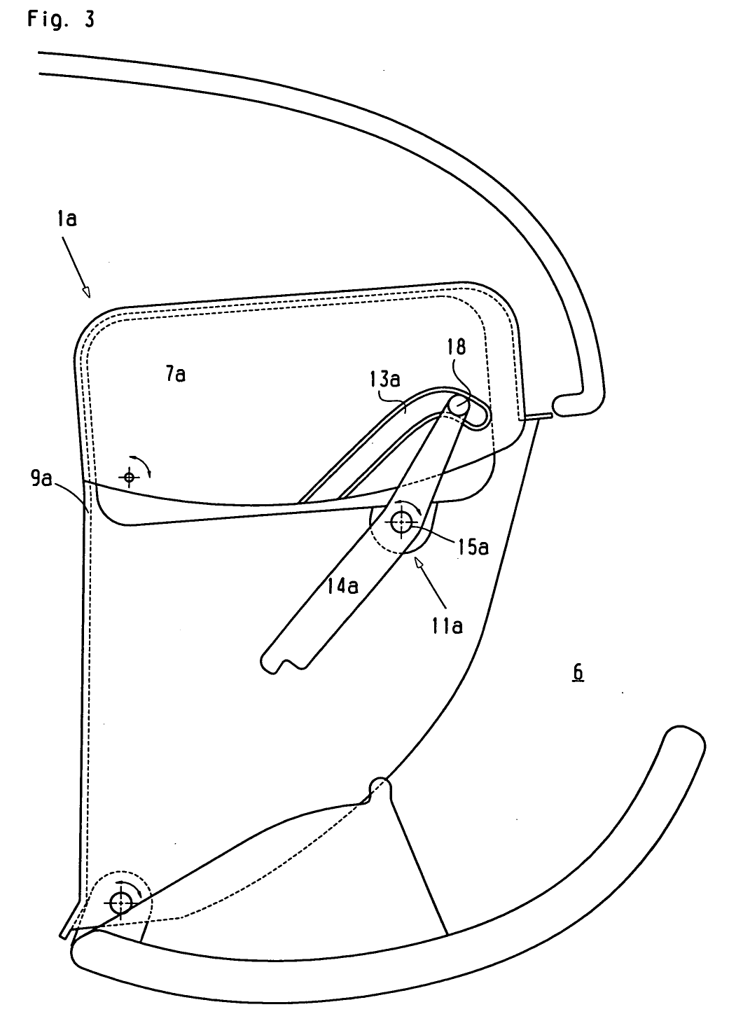

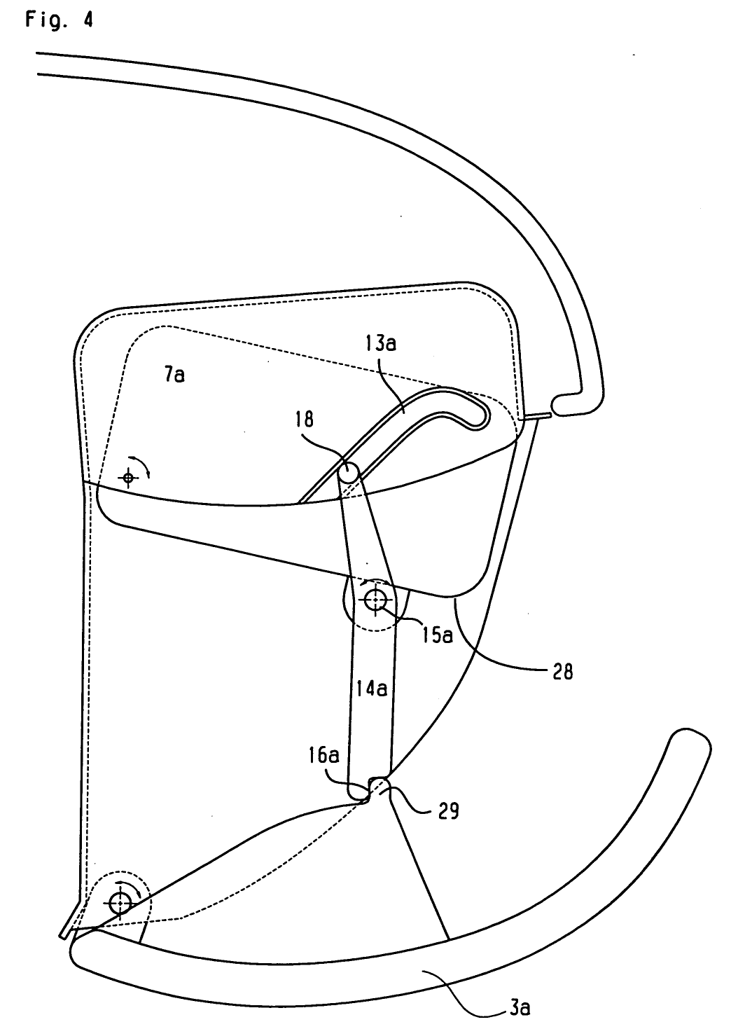

FIGS. 3 and 4 show an alternative embodiment of the storage compartment 1a, only the distinguishing elements of which will be described below. The lever mechanism 11a is formed by a lever 14a which is rotatably mounted by means of the lever 15a not on the housing 9a but on the internal compartment 7a. Accordingly, the control curve 13a is arranged on the housing 9a. The shape of the control curve 13a ensures that the lever mechanism 11a provides a locking action which prevents the internal compartment 7a from being lowered.

For lowering the internal compartment 7a, the lever 14a, provided it is accessible in the interior chamber 6 of the storage compartment 1a, can be pivoted by hand. Instead, it is also possible, however, to operate the lever 14a from the outside by means of a button and a slider (not shown) or the like. The guidance of the pin 18 in the control curve 13a initially brings about a slight overtravel movement beyond the position shown and then achieves the open position of the internal compartment 7a shown in FIG. 4. In that position the control surface 16a of the lever 14a makes contact with the control lug 29 on the cover 3a, so that the pivoting movement of the internal compartment 7a is stopped.

The closing of the internal compartment 7a can in turn be effected directly by lifting the internal compartment 7a at its underside 28 or indirectly by closing the cover 3a. In the second case, a force is transmitted to the lever 14a by means of the control lug 29 on the cover 3a. By virtue of the resultant moment on the lever 14a and the guidance of the pin 18 in the control curve 13a, a force pivoting the internal compartment 7 upwards is produced in the lever joint 15a. The pivoting movement is again completed by an overtravel movement and finally the position shown in FIG. 3 is reached.

It will be understood that each of the elements described above, or two or more together, may also find a useful application in other types of constructions differing from the types described above.

While the invention has been illustrated and described as embodied in storage compartment, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A storage compartment assembly, comprising a first storage compartment having a housing and an opening; an internal compartment arranged in said first storage compartment and having an access face, said internal compartment being mounted on said housing of said first storage compartment so as to be pivotable between a closed position in which said access face is unaccessible and an open position accessible via said opening of said first storage compartment; a lever mechanism; and a guide track means having a control curve, said lever mechanism and said guide track being formed so to couple said cover, said internal compartment and said housing so that when said first compartment is closed, said internal compartment is likewise pivoted from said open position into said closed position.

2. A storage compartment as defined in claim 1, wherein said lever mechanism has a lever which is pivotally mounted in said housing, said lever having a rear end provided with a pin which engages said control curve arranged on said internal compartment, said lever having a forward end provided with a control surface to which a force is transmittable when said cover is closed.

3. A storage compartment as defined in claim 2, wherein said lever is pivotally mounted on said internal compartment, said pin engaging in said control curve arranged in said housing.

4. A storage compartment as defined in claim 1; and further comprising a control slider arranged so that a transmission of force to said lever mechanism when said cover is closed is effected by said control slider, said control slider being mounted on said housing.

5. A storage compartment as defined in claim 1; and further comprising a control lug provided on said cover and formed so that a transmission of force to said lever mechanism when said cover is closed is effected by said control lug.

6. A storage compartment as defined in claim 1; and further comprising a manually unlockable catch which holds said internal compartment in said closed position.

7. A storage compartment as defined in claim 2, wherein said lever has at its rear end a displaceably mounted control head having a pin, and further comprising a torsion spring which connects said lever and said control head with one another and presses said control head against a closing pivoting movement of said lever, said control curve of said guide track means being formed so that when said internal compartment is being pivoted into said closed position an overtravel movement is performed which affects engagement of said internal compartment in a latch.
